(19) United States
(12) Patent Application Publication
(10) Pub. No.: US 2016/0147948 A1
(43) Pub. Date: May 26, 2016

(54) COMPARING MEDICAL DATA RECORDS

(71) Applicants: Andrew John Hewett, Erlangen (DE); Sascha Seifert, Konigsbach-Stein (DE)

(72) Inventors: Andrew John Hewett, Erlangen (DE); Sascha Seifert, Konigsbach-Stein (DE)

(21) Appl. No.: 14/945,702

(22) Filed: Nov. 19, 2015

(30) Foreign Application Priority Data
Nov. 24, 2014 (EP) 14194514.7

(51) Int. Cl. G06F 19/00

(52) U.S. Cl. CPC G06F 19/322

(57) ABSTRACT

The present embodiments relate to methods for comparing medical data. One method includes the acts of transmitting first medical data records from a first network to a central data storage; transmitting second medical data records from a second network to the central data storage; extracting first key data from the first medical data records in the central data storage; extracting second key data from the second medical data records in the central data storage; and calculating comparison values based on the first key data and the second key data.

This application claims the benefit of EP 14194514.7, filed on Nov. 24, 2014, which is hereby incorporated by reference in its entirety.

### TECHNICAL FIELD

The present embodiments relate to methods for comparing medical data.

### BACKGROUND

Nowadays, medical facilities collate data, for instance, on the use or utilization of examination devices. The acquired data may be compared with data available in literature. A direct comparison of a plurality of radiology facilities with different profiles of a patient distribution, examination types, and examination devices from different manufacturers is not possible.

### SUMMARY AND DESCRIPTION

The scope of the present invention is defined solely by the appended claims and is not affected to any degree by the statements within this summary. The present embodiments may obviate one or more of the drawbacks or limitations in the related art.

The object of the present embodiments is to increase the comparability of medical data.

According to a first aspect, the object is achieved by a method for comparing medical data. The method includes acts of transmitting first medical data records from a first network to a central data storage; transmitting second medical data records from a second network to the central data storage; extracting first key data from the first medical data records in the central data storage; extracting second key data from the second medical data records in the central data storage; and calculating comparison values based on the first key data and the second key data. By the method, medical data records are initially collated as base data to calculate key data. The key data is aggregated and harmonized. The key data is rendered comparable with the key data from other medical facilities by an automated system. This results in the technical advantage that the data records may be compared centrally with minimal use of resources.

The key data includes information, for example, on a duration of the examination, a period of vacant time between examinations or a technical specification of the examination device. The key data may also include information on an examination report, an imaging modality, a model of an examination device, an examination method performed, or an examined body part.

In an advantageous embodiment of the method the first and the second key data are extracted on the basis of an examination report, an imaging modality, a model of an examination device, an examination method performed or an examined body part.

In a further advantageous embodiment of the method, the first key data and the second key data are statistically averaged to calculate the comparison values. As a result the technical advantage is achieved, for instance, such that comparison values of statistically diverse key data may be generated with few computing steps.

In a further advantageous embodiment of the method, the key data of the first medical data records and of the second medical data records is stored in the central data storage. As a result, the technical advantage is achieved, for instance, such that the key data is permanently available in the central data storage.

In a further advantageous embodiment of the method, the comparison values are each calculated for the first network and the second network respectively. As a result, the technical advantage is achieved, for instance, such that the medical facilities that operate networks may be compared.

In a further advantageous embodiment of the method, the first and the second data records are anonymized before transmission to the central data storage. As a result the technical advantage is achieved, for instance, such that personalized data records may be consulted to calculate the comparison values.

In a further advantageous embodiment of the method, the central data storage is a database. As a result, the technical advantage is achieved, for instance, such that a rapid access to the key data is facilitated.

In a further advantageous embodiment of the method, the comparison values are transmitted to the first network or to the second network. As a result, the technical advantage is achieved, for instance, such that the medical facilities may evaluate the comparison values.

In a further advantageous embodiment of the method, the comparison values are displayed via display equipment. As a result, the technical advantage is achieved, for instance, such that the comparison values may be presented to a user.

In a further advantageous embodiment of the method, the first or the second network includes an imaging modality for generating data records. As a result, the technical advantage is achieved, for instance, such that the data records may be transferred directly from the medical modality to the central data storage.

In a further advantageous embodiment of the method, the imaging modality is managed on the basis of the calculated comparison values. As a result, the technical advantage is achieved, for instance, such that a closed loop is established, allowing improved management of the imaging modality to be achieved.

In a further advantageous embodiment of the method, the first or the second network includes a local image storage and communication system. As a result, the technical advantage is achieved, for instance, such that the images of medical data records may be stored locally and kept ready.

In a further advantageous embodiment of the method, the comparison values are stored in a database. As a result, the technical advantage is achieved, for instance, such that a rapid access to comparison values takes place.

In a further advantageous embodiment of the method, the first and second data records are DICOM files. As a result, the technical advantage is achieved, for instance, such that the data records are stored in a particularly suitable format.

According to a second aspect, the object is achieved by a computer system for comparing medical data, with a first network for transmitting first medical data records to a central data storage; a second network for transmitting second medical data records to the central data storage; an extraction unit for extracting first key data from the first medical data records in the central data storage and for extracting second key data from the second medical data records in the central data storage; and a comparison value generation device for calculating comparison values based on the first key data and the second key data. As a result, the same technical advantages are achieved, for instance, as by the method according to the first aspect.

### BRIEF DESCRIPTION OF THE DRAWINGS

FIG. 1 depicts a block diagram of an example of a method for comparing medical data.

FIG. 2 depicts a schematic illustration an example of a computer system for comparing medical data.

### DETAILED DESCRIPTION

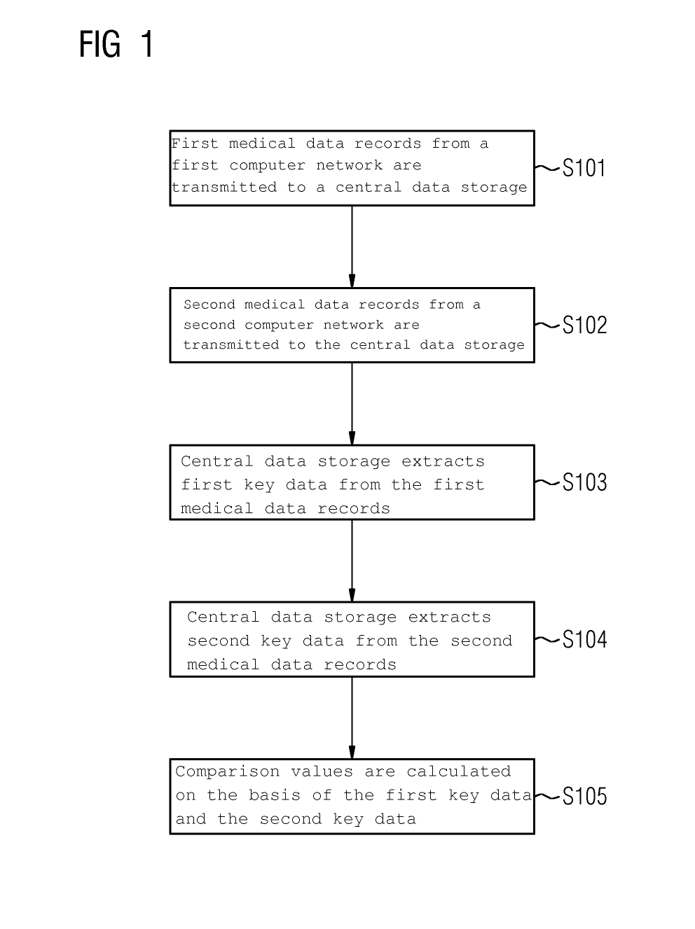

FIG. 1 depicts a block diagram of a method for comparing medical data. The method includes act S101 in which first medical data records from a first computer network of a medical facility, (e.g., a hospital), are transmitted to a central data storage. The central data storage is, for example, in the form of a cloud on the Internet or a database. The computer network is an amalgamation of different technical, primarily independent electronic systems, (e.g., computer or medical devices), which allows communication between the individual systems.

In act S102, second medical data records from a second computer network 101-2 of an alternative medical facility are transmitted to the central data storage 103. The central data storage 103 includes, for instance, a computer system with a hard disk or a database. In act S103, the central data storage extracts first key data from the first medical data records. In act S104, the central data storage extracts second key data from the second medical data records. In act S105, the central data storage then calculates comparison values (e.g., benchmarks) on the basis of the first key data and the second key data.

The comparison values may, for example, be calculated using a weighted or unweighted statistical averaging of the key data. The comparison values calculated centrally with minimal resources allow a standardized comparison of the two medical facilities.

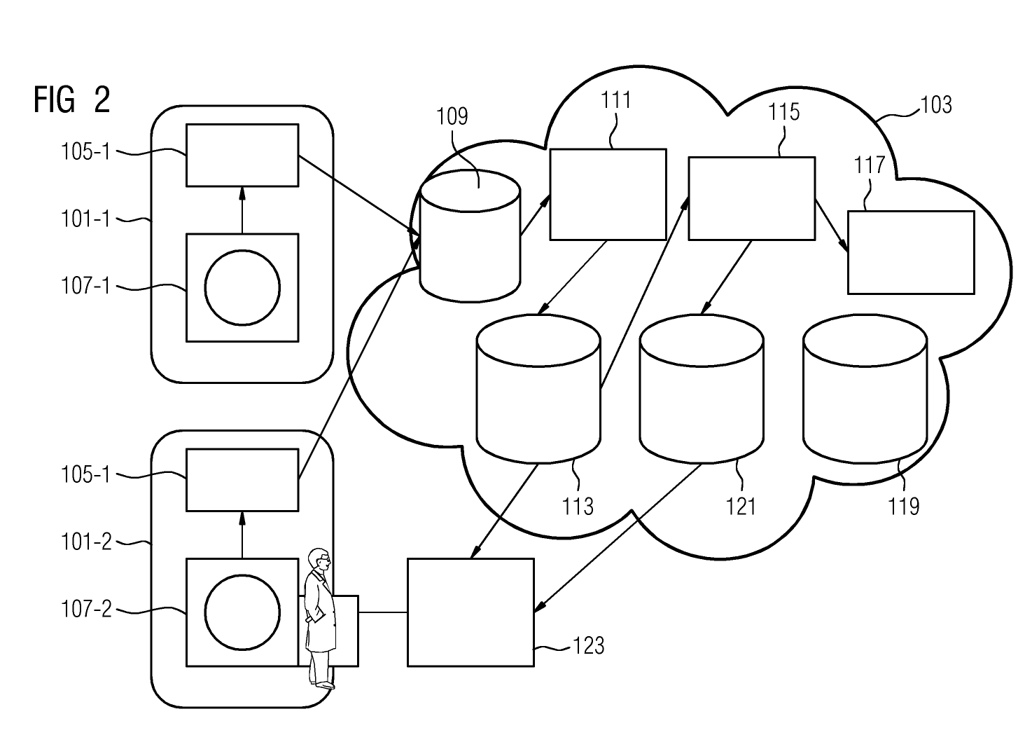

FIG. 2 depicts a schematic illustration of a computer system 100 for comparing medical data records. The data records are transmitted from the local networks 101-1 and 101-2 to a central data storage 103. The networks 101-1 and 101-2 are each, for example, arranged within a hospital and each include an application 105-1 and 105-2 and an imaging modality 107-1 and 107-2, (e.g., an MR scanner or CT scanner).

In act 5201, the medical imaging modality 107-1 and 107-2 continuously sends medical data records, (e.g., DICOM files), to the application 105-1 and 105-2 located within the facility. In addition, the application 105-1 and 105-2 may retrieve the medical data records from an alternative source, (e.g., from a local image storage and communication system (PACS—Picture Archiving and Communication System)).

In act S202, the applications 105-1 and 105-2 remove personalized data (e.g., PHI—Protected Health Information) from the medical data records and send these data records to the central data storage 109. In act S203, in an extraction unit 111, the uploaded data records are read out from the central data storage 109 and the key data (e.g., KPI—Key Performance Indicators) is extracted from the data records. The extraction unit 111 takes, for example, the form of a circuit or program executed in the data storage 103. In act S204, the extracted key data is stored in a database 113.

In act S205, the key data from the database 113 is read out by a comparison value generation device 115. The comparison value generation device 115 takes, for example, the form of a circuit or a program executed in the data storage 103. Comparison values for the first network 101-1 and the second network 101-2 are then calculated based on the average key data. In addition, the comparison values may be calculated by country, geographical region, or medical facility.

In act S206, a configurable comparison value analyzer 117 calculates groups of medical facilities according to predefined user setting values. To this end, the comparison value analyzer 117 uses a database 119, in which all of the affiliations of the medical facilities are stored.

In addition, the comparison value analyzer 117 calculates a plurality of similarity values for the medical facilities, which are derived from the data from the medical facility, (e.g., for devices, patients, or cases). This similarity value serves to identify an optimum medical partner facility that is similar in terms of structure or performance capability.

In act S207, the comparison values stored in the database 121 are updated. In acts S208 and S209, an application 123 presents the key data in a visual format and compares this with the comparison values calculated previously. The comparison values, which are provided by the application 123, may serve to optimize the utilization of imaging modalities 107-1 and 107-2, with which the data records were generated.

The comparison values are available practically in realtime and users of the system have access to current comparison values. In particular the comparison values for different groups of medical facilities are available.

A diagnostic imaging center as a medical facility may compare itself based on average comparison values against an alternative diagnostic imaging center in the same region, the same country or similar countries. A university hospital as a medical facility may compare itself based on the average comparison values against alternative university hospitals around the world.

Medical facilities may seek consent from other associated facilities to perform an individual comparison. Medical facilities may create groups of associated facilities to form a comparison community.

The comparison value analyzer 117 allows comparison partners with the same performance capability to be identified by comparing the key values, such as, for instance, medical facilities or groups thereof. It is also possible to find partners with similar improvement interests.

A similar environment of imaging modalities 107-1 and 107-2 may also be identified, such as, for instance, the same models and number of scanners, similar disease cases, derived examination reports, examination sequences, similar ages of patients, or gender structure.

The comparison value analyzer 117 may be enhanced to reverse calculations of key values. For given key values, for instance, from the comparison values and for a known medical device, patient, or case structure, measures may be determined that contribute toward the achievement of targets.

A further feature of the comparison value analyzer 117 is that it enables the user to simulate changes to workflows or an institutional structure and to measure the effect. This may, for instance, be performed by comparing against the most similar partner after the change has been implemented. The key data from this partner may be reported back and then used as forecast key data.

As a result of the method, medical institutions worldwide may provide medical data records from which key data is extracted. Comparison values are then calculated from the extracted key data. The key data may be presented in a visual format for a medical staff member and be compared with the comparison values.

The method provides a distributed system that connects several local centers together and assesses the medical data records of patients, examinations, and devices in order to calculate key data, to integrate the key data, and upload the integrated data to the central data storage 103. The key data may be compared with key data from other facilities and the results of the comparison may be transmitted back. The key data forms the basis for technically improving operational efficiency of a medical facility, such as, for instance, a radiology department in a hospital.

For example the efficient utilization of medical equipment, such as, for instance, CT or MR scanners may be determined on the basis of key data. The key data includes information for example on a duration of the examinations, a period of vacant time between examinations or a technical specification of the examination device.

The key data may also include information on an examination report, an imaging modality, a model of an examination device, an examination method performed, or an examined body part. This key data may be consulted for comparison with comparison values from other medical facilities.

In this way, it is possible to answer the question as to whether the medical facility is technically better or worse than other similar facilities from an operational perspective and which technical methods may be rendered more efficient. Optimum comparison partners may also be identified and interest groups established.

All features depicted and explained in conjunction with the individual embodiments may be provided in a different combination in the subject matter in order at the same time to realize their advantageous effects.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for comparing medical data, the method comprising:
transmitting first medical data records from a first network to a central data storage;
transmitting second medical data records from a second network to the central data storage;
extracting first key data, by an extraction unit, from the first medical data records in the central data storage;
extracting second key data, by the extraction unit, from the second medical data records in the central data storage; and
calculating comparison values, by a comparison value generation device, based on the first key data and the second key data.

2. The method as claimed in claim 1, wherein the first key data and the second key data are extracted based on an examination report, an imaging modality, a model of an examination device, an examination method performed, or an examined body part.

3. The method as claimed in claim 2, wherein the first key data and the second key data are statistically averaged to calculate the comparison values.

4. The method as claimed in claim 1, wherein the first key data and the second key data are statistically averaged to calculate the comparison values.

5. The method as claimed in claim 1, wherein the first key data and the second key data are stored in the central data storage.

6. The method as claimed in claim 1, wherein the comparison values are each calculated for the first network and the second network respectively.

7. The method as claimed in claim 1, further comprising:
anonymizing the first medical data records and the second medical data records before transmission to the central data storage.

8. The method as claimed in claim 7, further comprising:
transmitting the comparison values to the first network or to the second network.

9. The method as claimed in claim 8, further comprising:
displaying the comparison values via a display.

10. The method as claimed in claim 7, further comprising:
displaying the comparison values via a display.

11. The method as claimed in claim 1, wherein the central data storage is a database.

12. The method as claimed in claim 1, further comprising:
transmitting the comparison values to the first network or to the second network.

13. The method as claimed in claim 1, further comprising:
displaying the comparison values via a display.

14. The method as claimed in claim 1, wherein the first network or the second network comprises an imaging modality for generating data records.

15. The method as claimed in claim 14, wherein the imaging modality is managed based on the calculated comparison values.

16. The method as claimed in claim 1, wherein the first network or the second network comprises a local image storage and communication system.

17. The method as claimed in claim 1, further comprising:
storing the comparison values in a database.

18. The method as claimed in claim 1, wherein the first and second data records are DICOM files.

19. A computer system for comparing medical data, the computer system comprising:
a first network for transmitting first medical data records to a central data storage;
a second network for transmitting second medical data records to the central data storage;
an extraction unit for extracting first key data from the first medical data records in the central data storage and for extracting second key data from the second medical data records in the central data storage; and
a comparison value generation device for calculating comparison values based on the first key data and the second key data.
